(19) United States
(12) Patent Application Publication
(10) Pub. No.: US 2022/0010614 A1
(43) Pub. Date: Jan. 13, 2022

(54) DOOR SEAL WITH RODENT RESISTANT BARRIER FOR SEALING UP-AND-OVER DOORS IN BUILDINGS

(71) Applicant: RODEXIT APS, Holte (DK)

(72) Inventor: Bjørn Von Ryberg, Holte (DK)

(21) Appl. No.: 17/293,283

(22) PCT Filed: Nov. 5, 2019
(86) PCT No.: PCT/DK2019/050334

§ 371 Date: May 12, 2021

(30) Foreign Application Priority Data
Nov. 13, 2018 (DK) PA201800856

(51) Int. Cl. E06B 7/23; A01M 29/30; E06B 7/232

(52) U.S. Cl. CPC E06B 7/2314; E06B 7/232; A01M 29/30

(57) ABSTRACT

An elongated door seal for sealing the threshold gap of up-and-over doors in buildings, e.g. in garages, in order to repel mice and rats, and for cushioning the underside of the door blade, has A) an outer polymer material defining the form of the seal and made from one or more polymer materials, e.g. thermoplastic elastomers, B) at least 1 elongated sealing section intended to seal the threshold gap, C) at least one rodent proofing barrier comprising a plurality of substantially parallel elongated metal members embedded in the outer material of a sealing section with the elongated metal members arranged substantially in parallel to the longitudinal direction of the door seal and at some distance to each other, preferably arranged with substantially equal spacing, and D) at least one mounting section intended to be fastened to the door blade.

### CROSS-REFERENCE TO RELATED APPLICATIONS

This application is the U.S. National Stage of PCT/DK2019/050334 filed Nov. 5, 2019, which claims priority to Denmark Patent Application No. PA201800856, filed Nov. 13, 2018, the entire content of both are incorporated herein by reference in their entirety.

### FIELD OF THE INVENTION

The disclosure relates to oblong seals for sealing the threshold gap of up-and-over doors in buildings A) in order to avoid i) intrusion of pests especially rodents such as mice and rats and ii) influx of water and B) in order to control the physical atmosphere within a room behind the door by restricting air drafts and by reducing heat transfer so that the interior may be more effectively heated or cooled.

The disclosure also relates to assemblies of such seals and other products.

### BACKGROUND OF THE INVENTION

Rats and mice can transmit very dangerous contagious diseases, which can be transferred to humans e.g. via foods. Therefore, food enterprises are in many countries subject to one or more of the following requirements, which are aimed at reducing the risk for transfer of diseases to humans, when a rat or mouse has entered the premises of the food enterprise: A) The rat or mouse must be caught. B) All foods, which the rat or mouse may have been in contact with, must be destroyed. C) All parts of the enterprise, with which the rat or mouse may have been in contact, must be disinfected. D) The enterprise must close until the problem has been thoroughly solved.

Solving the problem is usually very costly and may run into several hundred thousand USD. Therefore, the annual losses due to rats and mice entering food enterprises are extremely high.

Rats and mice gnawing their way through door seals of up-and-over doors is a major problem. So is rats and mice passing through gaps left open by door seals, which are not sufficiently tight. Therefore, there is a substantial need for better and more rodent secure door seals for sealing the threshold gap of up-and-over doors.

Although the problem with rats and mice entering buildings through insufficiently sealed up-and-over doors has been known for more than a century it is still a very substantial problem.

### SUMMARY OF THE INVENTION

### Terminology

“Up-and-over door” means a vertically opening and closing door such as an up-and-over door, an overhead door or a roll-up door.

“Door blade” when used in relation to an up-and-over door means the up and down moving blade, wing, panel or leaf of the door, which blocks the entryway, when the door is closed—both in cases, A) where the door blade is divided into sections, B) where the door blade is in the form of a single board, and C) where the door blade is in the form of a flexible material, which can bend and e.g. be rolled into a coil when the door is opened.

“Substructure” when used in relation to an up-and-over door means the part of the structure at floor level right under the underside of the door blade, when the door is closed—e.g. said underlying part of the floor, door sill, door saddle or ground.

“Threshold gap” when used in relation to an up-and-over door means the gap between the underside of the door blade in closed position and the substructure.

“Elongated metal members” means A) metal wires, including flexible multi stranded metal wires, such as braided or twisted wires and single stranded wires, B) narrow metal strips, and C) combinations of metal wires and narrow metal strips.

1^{st} Aspect—A Door Seal for Rodent Proofing Up-and-Over Doors

According to a first aspect of the invention there is provided an oblong door seal for sealing the threshold gap of up-and-over doors in buildings e.g. in garages. The door seal comprises an outer material defining the form of the seal and a plurality of substantially parallel elongated metal members embedded in the outer material. The elongated metal members are arranged substantially in parallel to the longitudinal direction of the seal and at some distance to each other preferably arranged with a substantially equal spacing. The main purpose of the seal is to repel A) animals such as rodents including mice and rats B), insects, and C) water.

The seal may also help in controlling the physical atmosphere within a building by restricting air drafts and by reducing the heat transfer so one or more rooms in the building may be more effectively heated or cooled.

The door seal also serves as a shock absorber, which cushions and protects the door blade against damaging collisions with the substructure, when the door blade reaches its lowermost position during the closing of the up-and-over door.

The door seal comprises at least one oblong sealing section intended to seal the threshold gap. It may also comprise one or more the mounting sections, which are to be fastened to the door blade or to an adjacent surface. The door seal may comprise more than one sealing section. It may also comprise more than one mounting section. One or more mounting sections may be made of another material than one or more of the sealing sections and may be with or without the embedded elongated metal members. If so the material of the mounting sections in question may have a higher Shore A score e.g. an at least 4 points higher score or an at least 8 points higher score. At least one sealing section must be with an embedded barrier comprising a plurality of elongated metal members.

The purpose of the elongated metal members in the sealing section(s) is to secure against rodents such as rats and mice gnawing their way through the seal. The elongated metal members do in other words serve as a rodent proofing barrier.

The outer material may be made of one or more materials selected from: A) a polymer or plastic material, such as polyvinyl chloride, PVC, and/or a rubber material B) a polymer material, which may be a material comprising a natural polymer material such as rubber and/or a synthetic polymer material such as synthetic rubber or a thermoplastic material or a polyvinyl chloride, PVC, material, and C) a thermoplastic elastomer (TPE) such as a thermoplastic vulcanizate (TPV)—e.g. Santoprene™, such as Santoprene™ 201-73, Santoprene™ 201-80 or Santoprene™ 201-87.

The Shore A hardness score of the outer materials of at least one of the sealing sections may be 45-95 such as 60-93, such as 65-88 such as 70-87, such as about 78.

In order to use the door seal as a rodent proof door seal, the elongated metal members shall be dimensioned and made of a material, which rats and mice cannot bite their way through. Furthermore, the distance between the elongated metal members shall be so small, that rats or mice cannot pass between the elongated metal members and through the door seal after having gnawed off even a substantial part of the outer material.

At least 2 of the elongated metal members in the sealing section(s) may be arranged at a distance to the nearest elongated metal member (i.e. to the neighboring elongated metal member) which is no larger than 20 mm, such as no larger than 19 mm, such as no larger than 18 mm, such as no larger than 17 mm, such as no larger than 15 mm, such as no larger than 12 mm, such as no larger than 10 mm, such as no larger than 9 mm, such as no larger than 8 mm, such as no larger than 7 mm, such as no larger than 6 mm, such as no larger than 5 mm, such as no larger than 4 mm, such as no larger than 3 mm, or such as no larger than 2 mm. It is preferred that the distance between the neighboring elongated metal members is uniform.

At least 2 of the elongated metal members may be made of a selection of the following materials or alloys thereof: a) iron b) steel c) stainless steel d) spring steel e) welding wire filler metal such as 308L, 316L, 309L and 347 filler metal.

At least 2 of any elongated metal members in the form of wires may have a thickness or diameter of at least 0.4 mm, at least 0.6 mm, at least 0.7 mm, at least 0.8 mm, at least 0.9 mm, at least 1 mm, at least 1.1 mm, at least 1.2 mm, at least 1.3 mm, at least 1.4 mm, at least 1.5 mm, at least 1.6 mm, at least 1.7 mm, at least 1.8 mm, at least 1.9 mm, at least 2.0 mm, at least 2.1 mm, at least 2.2 mm, at least 2.4 mm, at least 2.7 mm, or at least 3 mm.

At least 2 of any elongated metal members in the form of metal strips may have a width of at least 0.6 mm, 0.8 mm, at least 1 mm, at least 1.5 mm, at least 2 mm, or at least 2.5 mm.

In a possible implementation form, the number of elongated metal members in at least one of the sealing sections of the door seal, is at least 2, such as at least 4, such as at least 6, such as at least 8, such as at least 10, such as at least 12, such as at least 14, such as at least 16, such as at least 18, such as at least 20.

The door seal or the sealing section may be in the form of a blade seal, a bubble seal or another seal type. One or more of the sealing sections may be solid, while one or more may be hollow.

The door seal may be produced by a single extrusion process or in a single insert molding process, in which case the outer material, in which the elongated metal members are embedded, is made out of a single component—as opposed to e.g. a sandwich construction where several components have been joined. One material may be used for one part of the outer material and another material for another part of the outer material. If so, one of the materials must be provided by one or more inlets to the extrusion die or the mold while one or more other inlets must be used for providing the other material in such a way that the materials end up in the places, where they are desired to constitute the different parts.

When the door seal is extruded, the profile of the extruded door seal is determined by the design of the outlet part of the extrusion die. Each of the elongated metal members may be fed into the extrusion die in the same way as wires are fed into an extrusion die when producing plastic covered electric cables. The crosshead extrusion process which is widely used for coating wires and cables may be used.

### BRIEF DESCRIPTION OF THE DRAWINGS

FIG. 1 is a perspective view of a U-shaped door seal;

FIG. 2 is a cross sectional view of the U-shaped door seal of FIG. 1;

FIGS. 3.1-3.3 are cross sectional views of door seals with cross sections in the form of a square, a rectangle or a trapezoid;

FIGS. 3.4-3.5 are cross sectional views of door seals where the lower part is substantially rounded or substantially pointed;

FIG. 4 is a cross sectional view of the U-shaped door seal of FIG. 1 and FIG. 2 with some added features;

FIG. 5 is a cross sectional view of a mounting strip with 2 T-shaped mounting slots;

FIG. 6.1 is a cross sectional view of a door seal with 2 L-shaped mounting sections;

FIG. 6.2 is a cross sectional view of a mounting strip with 2 L-shaped mounting slots and the door seal of FIG. 6.1;

FIG. 7.1 is a cross sectional view of a door seal with 2 T-shaped mounting sections;

FIG. 7.2 is a cross sectional view of a mounting strip with 2 T-shaped mounting slots for mounting the door seal of FIG. 7.1; and

FIG. 8 is an elevation view of an assembly of the door blade of an up-and-over door, the U-shaped door seal of FIGS. 1, 2, and 4 and a sensor.

### DETAILED DESCRIPTION OF THE INVENTION

2^{nd} Aspect—A Substantially U-Shaped Door Seal for Rodent Proofing Up-and-Over Doors

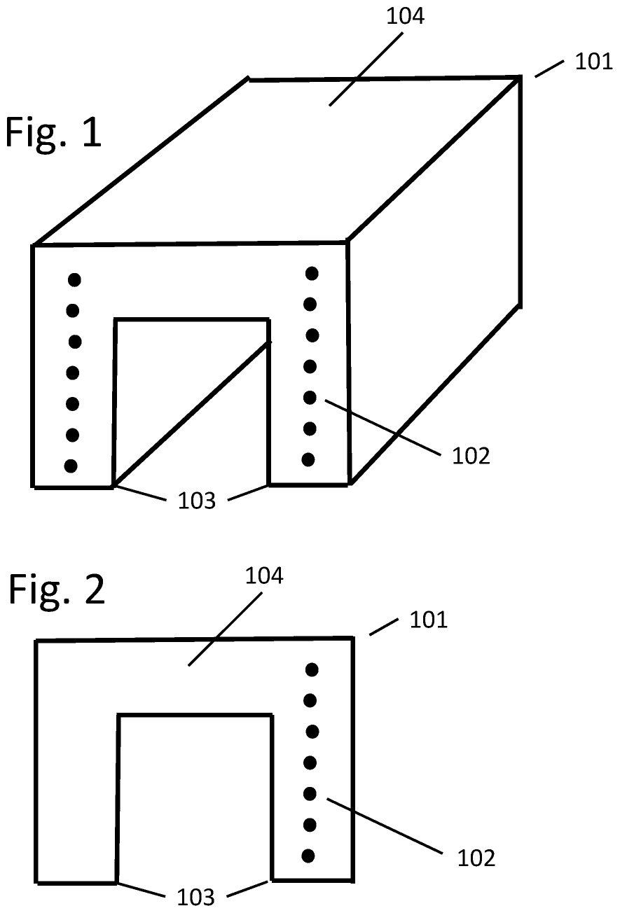

FIG. 1 is a perspective view of a substantially U-shaped door seal (101) according to the first aspect of the invention with an embedded and rodent proof barrier of elongated metal members (102). The door seal is to be mounted on the underside of the door blade of an up-and-over door with the cavity of the outer material i.e. the opening of the U pointing down and away from the underside of the door blade. The door seal comprises 2 sealing sections in the form of the two blade-shaped wings (103) of the U. In each of the two blade-shaped wings (103) there is an embedded rodent proof barrier comprising a plurality of elongated metal members (102). There is no rodent proof barrier in the horizontal mounting section (104) connecting the two blade-shaped wings (103). The lowermost part of the blade-shaped wings (103) may be made of a more elastic material than the rest of the blade shaped wings (103) so the seal better can fill and seal indentations in uneven substructures, when the up-and-over door is closed.

In a possible implementation form of the door seal (101), there are at least 2 elongated metal members (102) in at least one mounting section (104). One purpose of the elongated metal members (102) in the mounting section (104) is to reinforce the section so it becomes possible to mount the door seal securely by means of screws with screw heads spanning over at least two neighboring elongated metal members embedded in the mounting section (104).

In a possible implementation form of the door seal (101) the cavity is suitable for holding a sensor A) which can detect obstacles e.g. the head of a person when the up-and-over door closes, and the door blade goes down, and B) when detecting such obstacles can trigger a stopping mechanism so the further downwards movement of the door blade is stopped.

The door seal (101) may be fastened to the door blade of the up-and-over door by means of double-sided tape, glue, screws, rivets or other fasteners. Before taping or gluing the door seal and/or the up-and-over door may be primed with a primer in order to improve the strength of the joint.

One side of a mounting section (104) may be provided with double sided tape which can hold the seal in place during the mounting process A) so the user does not need to use one hand for holding the door seal in place while mounting and B) the user can use both hands for handling tools, fasteners and—if the seal is to mounted with a separate mounting strip—a mounting strip.

One or more substantially blade-shaped wings may have no embedded elongated metal members. If so, the blade-shaped wings are sealing sections with no rodent proof barrier of elongated metal members.

There may be more than 2 sealing sections. If so, there may be more than one sealing section without an embedded barrier of elongated metal members, but there must be at least one sealing section with such a barrier.

FIG. 2 is a cross sectional view of the door seal (101) of FIG. 1 with an embedded barrier of elongated metal members (102) in only one of the 2 blade-shaped wings.

The cross section of the door seal may have another basic shape than substantially U-shaped. It must, however, have at least one downwards pointing cavity and at least two downwards pointing sealing sections in the form of substantially blade-shaped wings.

The cross section of the door seal may measure 2-15 cm×2-15 cm, such as 3-10 cm×3-10 cm, such as 4-8 cm×4-8 cm, such as 5-6 cm×5-6 cm.

The thickness (horizontal measure on FIG. 2) of the uppermost part of at least one of the sealing sections (103) may be 3-50 mm, such as 4-40 mm, such as 5-30 mm such as 6-20 mm, such as 7-15 mm such as 8-12 mm. The thickness of the uppermost part of the sealing sections may be different and the material, of which they are made may be different—e.g. the materials may be chosen so they have different Shore A score. Such differences may give the 2 sealing sections different sealing properties and that may improve their combined sealing properties. Such differences may also be used in order to optimize the combined sealing properties and shock absorbing/cushioning properties. The difference in thickness may be at least 1 mm, such as at least 2 mm, such as at least 4 mm, such as at least 7 mm, such as at least 10 mm, such as at least 13 mm, such as at least 16 mm, such as at least 19 mm, such as at least 22 mm. The difference in Shore A score may be at least 2, such as at least 4, such as at least 6, such as at least 8, such as at least 10, such as at least 12, such as at least 14, such as at least 16.

The height (vertical measure on FIG. 2) of at least one of the sealing sections (103) may be 5-100 mm, such as 10-80 mm, 20-70 mm, 30-60 mm, 40-50 mm. The height of the sealing sections may be different.

The distance from the lowermost elongated metal member (102) in at least one of the sealing sections (103) to the lower edge of the sealing section may be in the range of 1-16 mm, such as 2-10 mm, such as 3-6 mm, such as 3-4 mm.

The distance from the uppermost elongated metal member (102) in at least one of the sealing sections (103) to the upper edge of the sealing section may be in the range of 1-16 mm, such as 2-10 mm, such as 3-6 mm, such as 3-4 mm.

The lower part of at least one of the sealing sections (103) may be made of a more flexible material with a lower Shore A score than the uppermost part of the sealing section in order to increase the flexibility and thereby the sealing properties of the sealing section (103). The difference in Shore A score may be at least 2, such as at least 4, such as at least 6, such as at least 8, such as at least 10, such as at least 12, such as at least 14, such as at least 16.

The ratio between the thickness (horizontal measure on FIG. 2) of the uppermost part of at least one of the sealing sections (103) and the Shore A hardness score of the uppermost part of the sealing section (indirectly reflecting the flexibility of the material) may be in such a way that the result of a multiplication of the thickness in mm by the Shore A score is a number in the range of 350-2,000, such as 400-1,500, such as 500-1,000.

In a specific embodiment the substantially U-shaped door seal (101) is characterized by the following: The door seal has 2 sealing sections (103) and one mounting section (104) with a total width (horizontal measure on FIG. 2) of 50 mm and a total height (vertical measure on FIG. 2) of 50 mm, B) the thickness (horizontal measure on FIG. 2) of the uppermost part of the sealing sections is 15 mm, C) the gap between the 2 sealing sections is 20 mm D) the elongated metal members (102) are made of stainless steel 308L welding wire with a diameter of 1 mm, E) the distance between neighboring metal wires (102) is 5 mm, F) the number of metal wires (102) in one of the sealing sections (103) is 7, while there are no metal wires (102) in the other sealing section (103), G) there are 2 wires in the mounting section (104), H) the outer material of one of the sealing sections is made for Santoprene™ 201-73, while the other one is made of Santoprene™ 201-80, I) the distance from the bottom edge of the sealing section (103) with embedded wires to the lowermost elongated metal wire (102) is 3 mm and J) the distance from the uppermost wire (102) in the sealing section (103) with embedded wires to the upper edge of the sealing section is 3 mm.

3^{rd} Aspect—A Substantially Square, Rectangular or Trapezoid Door Seal

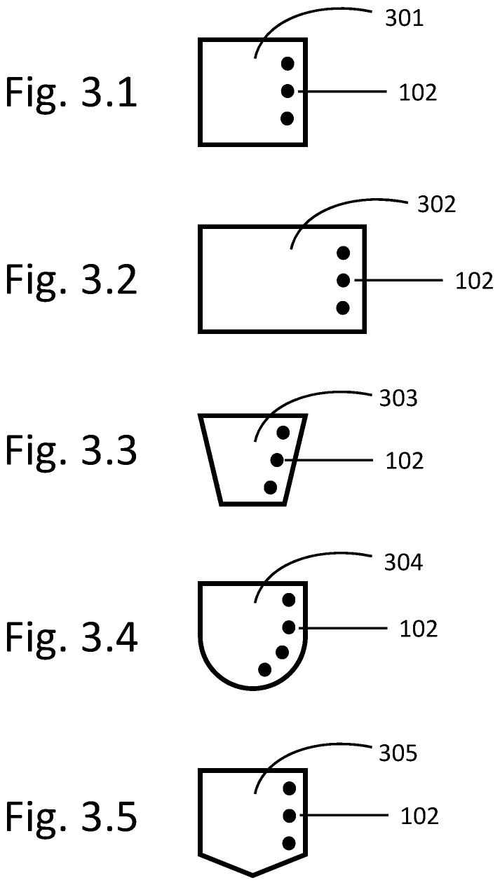

FIGS. 3.1-3.3 are cross sectional views of a door seal according to the first aspect comprising an oblong sealing section (301, 302, or 303) with an embedded rodent resistant barrier of a plurality of elongated metal members (102). The cross sections of the 3 different sealing sections (301, 302, and 303) are respectively substantially square, substantially rectangular and substantially trapezoid.

In order to increase the flexibility of the lower part and thereby the sealing properties of the door seal the lower part of the sealing section (301, 302, or 303) may be rounded or pointed as shown on the sealing sections (304 and 305) in FIGS. 3.4 and 3.5.

The lower part of the sealing section (301, 302, or 303) may be made of a more flexible material with a lower Shore A score than the uppermost part in order to increase the flexibility of the lower part and thereby the sealing properties of the sealing section (301, 302 or 303). The difference in Shore A score may be at least 2, such as at least 4, such as at least 6, such as at least 8, such as at least 10, such as at least 12, such as at least 14, such as at least 16.

The ratio between the thickness of the uppermost part of the sealing section (301, 302 or 303) and the Shore A hardness score of the uppermost part of the sealing section may be so that the result of a multiplication of the thickness in mm by the Shore A score is a number in the range of 350-2,000, such as 400-1,500, such as 500-1,000.

The thickness (horizontal measure on FIGS. 3.1-3.3) of the uppermost part of the sealing section (301, 302, or 303) may be 10-150 mm, such as 15-100 mm, such as 20-80 mm, such as 25-60 mm, such as 30-50 mm.

The height (vertical measure on FIGS. 3.1-3.3) of the sealing section (301, 302, or 303) may be 10-150 mm, such as 15-100 mm, such as 20-80 mm, such as 25-60 mm, such as 30-50 mm.

The distance from the lowermost elongated metal member (102) in the sealing section (301, 302, or 303) to the lower edge of the sealing section may be in the range of 1-16 mm, such as 2-10 mm, such as 3-6 mm, such as 3-4 mm.

The distance from the uppermost elongated metal member (102) in the sealing section (301, 302, or 303) to the upper edge of the sealing section may in the range of 1-16 mm, such as 2-10 mm, such as 3-6 mm, such as 3-4 mm.

The door seal may be fastened to the door blade of the up-and-over door by means of double-sided tape, glue, screws, rivets or other fasteners. Before taping or gluing the door seal and/or the up-and-over door may be primed with a primer in order to improve the strength of the joint.

One side of the door seal may be provided with double sided tape which can hold the seal in place during the mounting process A) so the user does not need to use one hand for holding the door seal in place while mounting and B) the user can use both hands for handling tools, fasteners and—if the seal is to mounted with a separate mounting strip—a mounting strip.

4^{th} Aspect—A Door Seal with Added Features

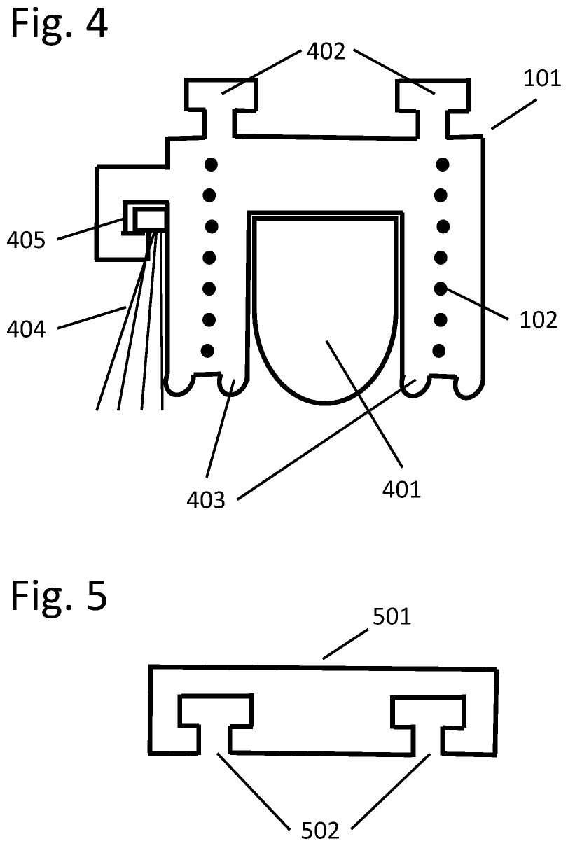

FIG. 4 is a cross sectional view of the door seals of FIG. 1 and FIG. 2 with the following added features:
a) A sensor (401) for stopping the closing movement of the door blade downwards when the sensor detects some sort of obstacle e.g. the head of a person.
b) Oblong attaching members (402) for attaching the door seal to the underside of the door blade of the up-and-over door. The attaching members (402) are intended to fit into corresponding and oblong slots in the underside of the door blade or in a separate mounting strip. The number of attaching members (402) and corresponding slots may be at least 1, at least 2, at least 3 or at least 4. In FIG. 4 the attaching members (402) are substantially T-shaped. They may have other suitable cross-sectional shapes such as A) substantially the cross-sectional shape of a samba drum beater or B) substantially the shape of a trapezoid with the broadest part of the trapezoid pointing upwards and being intended to fit into a mounting slot.
c) Relatively small and therefore relatively flexible oblong parts (403) protruding from the underside of the one or more sealing sections. The number of such protruding parts (403) on a sealing section may be at least 1, at least 2, at least 3 or at least 5. The breadth of at least one of the protruding parts (403) may be from at least 10%, at least 20%, at least 30%, at least 40%, at least 50% or at least 60% of the thickness (horizontal measure on FIG. 2) of the uppermost part of the sealing section (103), on which it is placed. The breadth of at least one of the protruding parts may be in the range 1-5 mm, 2-4 mm or around 3 mm. The height may likewise be in the range 1-5 mm, 2-4 mm or around 3 mm. The protruding parts (403) can due to their size and flexibility improve the capability of the door seal to fill and seal small indentations in an uneven substructure. At least one of the protruding parts (403) may be made from a softer material than the uppermost part of the sealing section. This will further increase the flexibility and the said capability will accordingly be further improved. The difference in Shore A score may be at least 2, such as at least 4, such as at least 6, such as at least 8, such as at least 10, such as at least 12, such as at least 14, such as at least 16.
d) An oblong brush strip (404) mounted in an oblong slot (405) formed by the outer material of the door seal. The fibers of the brush strip protrude slightly under the lowermost part of the sealing section (403). The brush fibers are good at filling and sealing small indentations in an uneven substructure and can, therefore, provide an extra sealing effect.

Any number of and any combination of the above described features may be added to the door seal (101) of FIG. 1 and FIG. 2. Thus, the resulting product may be e.g. an assembly of the door seal (101) and a sensor (401), B) an assembly of the door seal (101) and an oblong brush strip (404) or C) an assembly of the door seal (101), the sensor (401) and an oblong brush strip (404).

A door seal with the abovementioned oblong attaching members (402) can be attached to the mounting strip (501) of FIG. 5 when the strip is equipped with oblong mounting slots (502) with a cross sectional shape corresponding to the cross-sectional shape of the oblong attaching members (402). The mounting strip (501) may be mounted on the underside of door blades of up-and-over doors, which have not been equipped with corresponding oblong mounting slots, so it becomes possible to attach the door seal by means of the oblong attaching members (602) in spite of the lack of corresponding slots on the underside of the door blade.

When a door seal with the abovementioned oblong attaching members (402) is mounted in the described way either directly on the underside of a door blade or indirectly via a mounting strip it is very easy and requires no tools to replace the door seal when it has been worn out or damaged.

One or more of the added features described above under item b, c, and d may in the same way be added to the door seals according to the 3^{rd} aspect, likewise resulting in the creation of similar assemblies of door seals and brush strips.

5^{th} Aspect—Bendable Blade Shaped Seals and Corresponding Mounting Strips

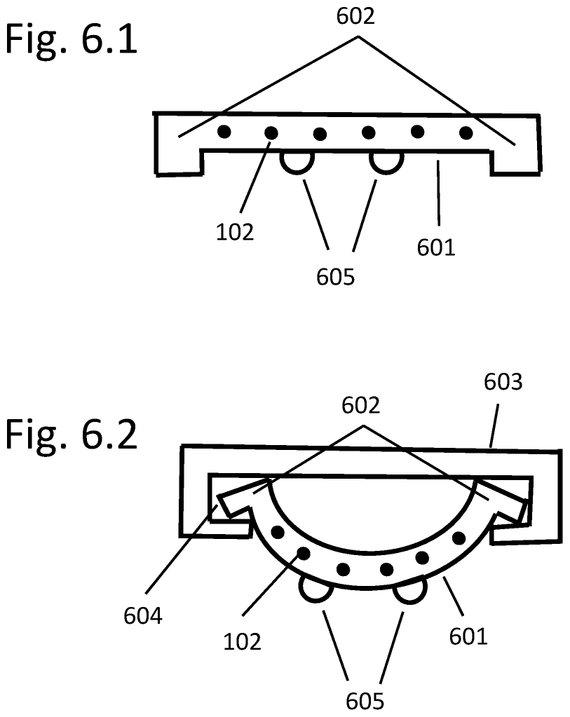

FIG. 6.1 is a cross sectional view of an elastic door seal according to the first aspect comprising a blade shaped sealing section (601) with an embedded rodent resistant barrier of elongated metal members (102) and 2 oblong and substantially L-shaped mounting sections each with a substantially L-shaped attaching member (602) on opposite sides of the cross section of the sealing section (601). There are no embedded elongated metal members (102) in the mounting sections. The mounting sections (602) are substantially parallel to the elongated metal members of the sealing section and the longitudinal direction of the door seal.

When bend as shown in FIG. 6.2 the door seal can be attached A) to a mounting strip (603) equipped with oblong mounting slots (604) with a cross sectional shape corresponding to the cross-sectional shape of the attaching members of the mounting sections of the door seal or to B) the underside of the door blade of an up-and-over door with similar oblong mounting slots.

When bend and mounted as shown in FIG. 6.2 in such an oblong mounting strip (603) with the substantially L-shaped attaching members of the mounting sections (602) in the corresponding mounting slots (604), the elasticity of the sealing section will automatically press the mounting sections outwards and into the slots thereby keeping them in place.

The mounting strip (603) may be mounted on the underside of a door blade, which have not been equipped with corresponding oblong mounting slots, so it becomes possible to attach the door seal to the door blade by means of the oblong mounting sections (602) despite the lack of corresponding slots on the underside of the door blade.

When the door seal is mounted in the described way either directly on the underside of a door blade or indirectly via a mounting strip, it is very easy and requires no tools or fasteners to replace the door seal when it has been worn out or damaged.

The seal with the L-shaped mounting sections (602) can be mounted simply by A) compressing the seal a little (i. e. pressing the 2 L-shaped mounting sections towards each other), B) inserting the 2 L-shaped mounting sections into the corresponding L-shaped mounting slots (604) and C) releasing the seal so the sealing section (601) straightens out and thereby presses the 2 L-shaped mounting sections into the corresponding L-shaped slots. That is a lot easier than mounting a door seal with T-shaped mounting sections, that has to be dragged from one end of the corresponding T-shaped slots all the way to the other end—a hard task due to the substantial friction and a job that requires 2 persons dragging.

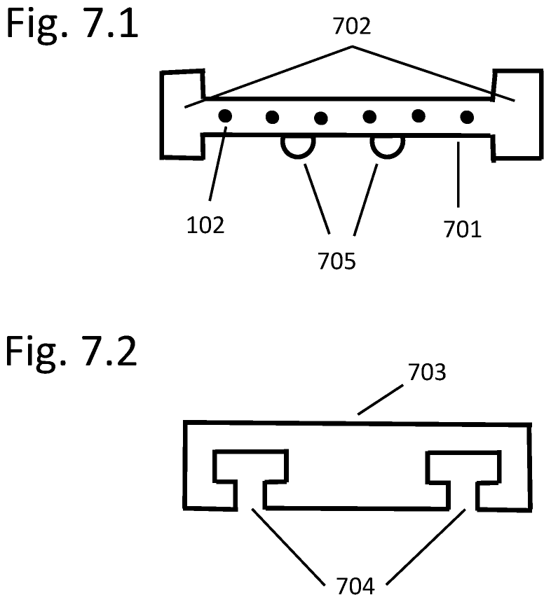

FIG. 7.1 is a cross sectional view of an elastic door seal according to the first aspect comprising a blade shaped sealing section (701) with an embedded rodent resistant barrier of elongated metal members (102) and 2 oblong and substantially T-shaped mounting sections (702) on opposite sides of the cross section of the sealing section (701). The cross section of the mounting sections (702) may also be substantially samba drum beater-shaped or substantially trapezoid-shaped. There are no embedded elongated metal members (102) in the mounting sections (702).

The mounting sections (702) are substantially parallel to the elongated metal members of the sealing section and the longitudinal direction of the door seal. There may be at least 1 such mounting section, such as at least 2, such as at least 3, such as at least 4.

A door seal with such mounting sections (702) can be attached A) to the mounting strip (703) of FIG. 7.2, when the strip is equipped with a corresponding number of oblong mounting slots (704) with a cross sectional shape corresponding to the cross sectional shape of the mounting sections (702) or B) directly to the underside of an up-and-over door with corresponding mounting slots (704).

The mounting strip (703) may be mounted on the underside of the door blade of an up-and-over door, which have not been equipped with corresponding oblong mounting slots, so it becomes possible to attach the door seal by means of the substantially T-shaped mounting sections (702) in spite of the lack of corresponding slots on the underside of the door blade.

When a door seal with the abovementioned oblong mounting sections (702) is mounted in the described way either directly on the underside of a door blade or indirectly via a mounting strip (703), it requires no tools to replace the door seal when it has been worn out or damaged.

The breadth of the door seals of FIGS. 6.1 and 7.1 (horizontal measure on the figures) and the thickness of the uppermost part of the sealing sections (601 and 701) of the door seals of FIGS. 6.1 and 7.1 (vertical measure of the sealing sections on the figures) may be: 4-30 cm broad and 2-20 mm thick such as A) 4-8 cm broad and 2-6 mm thick, B) 8-12 cm broad and 3-8 mm thick C) 10-15 cm broad and 4-10 mm thick D) 15-20 cm broad and 5-15 mm thick or E) 20-30 cm broad and 6-20 mm thick.

The following features may be added to the implementation forms of this 5^{th} aspect:
a) Relatively small and therefore relatively flexible oblong parts (605 and 705) protruding from one side of the sealing section (601 and 701) and extending parallel to the longitudinal direction of the sealing section (601 and 701). The number of such protruding parts (605 and 705) on a sealing section may be at least 1, at least 2, at least 3 or at least 5. The breadth of at least one of the protruding parts (605 and 705) may be in the range 1-5 mm, 2-4 mm or around 3 mm. The height may likewise be in the range 1-5 mm, 2-4 mm or around 3 mm. The protruding parts (605 and 705) can due to their size and flexibility improve the capability of the door seal to fill and seal small indentations in an uneven substructure. One or more of the protruding parts (605 and 705) may be made from a softer material than the main part of the sealing section (601 and 701). This will further increase the flexibility and the said capability will accordingly be further improved. The difference in Shore A score may be at least 2, such as at least 4, such as at least 6, such as at least 8, such as at least 10, such as at least 12, such as at least 14, such as at least 16.
b) An oblong brush strip mounted in an oblong slot formed by the outer material of the door seal. The fibers of the brush strip should protrude slightly under the lowermost part of the sealing section (601 and 701) when the seal is mounted in the corresponding L-shaped or T-shaped slots (604 and 704). The brush fibers will be good at filling and sealing small indentations in an uneven substructure and can, therefore, provide an extra sealing effect.

6^{th} Aspect—Assemblies of Door Seals and Mounting Strips

The 6^{th} aspect is 3 different assemblies of A) door seals for up-and-over doors and B) mounting strips.

Firstly, it is an assembly of A) any of the doors seals of the 2^{nd} and 3^{rd} aspects equipped with one or more of the added features (401, 402, 403, 404 and 405) shown in FIG. 4 and described as a part of the 4^{th} aspect under items a, b, c, and d including at least the attaching members (402) and B) the mounting strip (501) described in connection with FIG. 5.

Secondly, it is an assembly of A) the door seal of the 5^{th} aspect described in connection with FIGS. 6.1 and 6.2 and B) the mounting strip (603) described in connection with FIG. 6.2.

Thirdly, it is an assembly of A) the door seal of the 5^{th} aspect described in connection with FIGS. 7.1 and 7.2 and B) the mounting strip (703) described in connection with FIG. 7.2.

7^{th} Aspect—Assemblies Involving Door Seals and Door Blades of Up-and-Over Doors

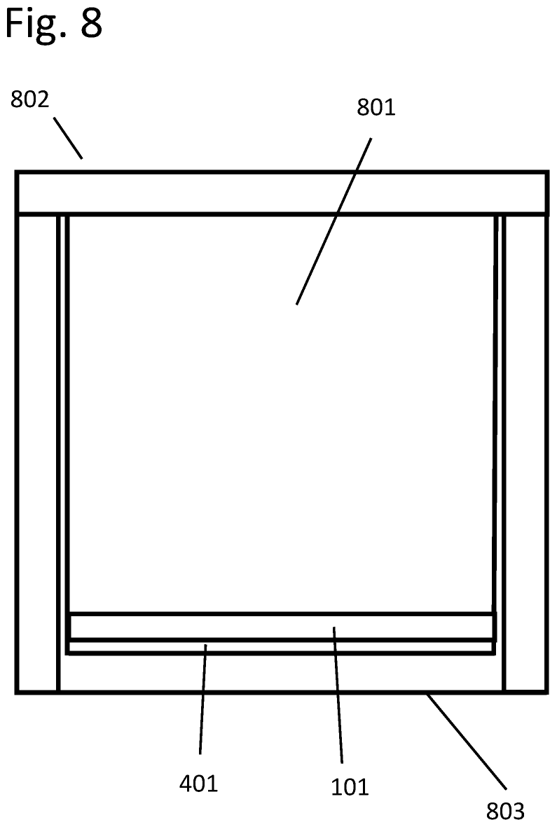

FIG. 8 is an assembly of A) a door seal (101), according to the 2^{nd} aspect, B) the sensor (401) described in connection with FIG. 4, C) a sensor controlled mechanism [not visible in FIG. 8], which can stop the downward closing movement of the door blade, when the sensor during the closing movement hits the head of a person or some other sort of detectable obstacle, and D) a door blade (801) of an up-and-over door (802).

The substructure (803) is shown by the lowermost horizontal line.

The door blade is shown in a semi-closed position.

The assembly may also comprise the mounting strip described in connection with FIG. 5.

Instead of i) the door seal according to the 2^{nd} aspect (101), ii) the sensor (401) described in connection with FIG. 4 and iii) the sensor controlled mechanism the assembly may comprise A) a door seal according to the 3^{rd} aspect described in connection with FIGS. 3.1-3.5 or B) any of the door seals of the 5th aspect described in connection with FIGS. 6.1, 6.2, 7.1 and 7.2 together with or without the mounting strips of the 5^{th} aspect described in connection with FIGS. 6.2 and 7.2.

One or more of the following 3 extra features of the 4^{th} aspect described in connection with FIG. 4 under the items b, c, and d may be added to the assembly: A) attaching members, B) small and flexible parts protruding from the underside of a sealing section, and C) a brush strip with a corresponding mounting slot. However, the attaching members are not relevant, when the door seal is a door seal according to the 5^{th} aspect.

Aspect—Methods for Rodent Proofing Up-and-Over Doors 8^{Th}

The 8th aspect is a method for rodent proofing an up-and-over door comprising the step of mounting a door seal according to any of the implementation forms of the 1st, 2nd, 3rd, 4th and 5th aspects of the invention on the door blade of the up-and-over door.

1.-14. (canceled)

15. An elongated door seal for sealing a threshold gap of an up-and-over door in a building, comprising:
an outer body of polymer material defining a form of the seal and made from one or more polymer materials, the outer body of polymer material defining at least one elongated sealing section;
at least one rodent proofing barrier comprising a plurality of substantially parallel elongated metal members embedded in the at least one elongated sealing section of the outer body of material, the elongated metal members arranged substantially in parallel to a longitudinal direction of the door seal and spaced apart from each other; and
at least one mounting section;
wherein;
at least one of the elongated sealing sections of the outer body of material has a shore A score in a range of 45-95;
at least two of the elongated metal members are selected from i) metal wires with a diameter of at least 0.6 mm and ii) at least 0.6 mm wide metal strips; and
a distance between at least two neighboring ones of the plurality of elongated metal members is no larger than 15 mm.

16. The elongated door seal according to claim 15, wherein:
the at least one elongated sealing section comprises at least two elongated sealing sections that are 3-50 mm thick and 5-100 mm high, the at least two elongated sealing sections comprising downwards pointing and substantially blade-shaped wings; and
the outer body of polymer material further defining at least one elongated downwards pointing cavity;
wherein at least one of the two elongated sealing sections having;
the shore A score in the range of 45-95;
the plurality of substantially parallel elongated metal members embedded therein;
a distance from a lower edge of the at least one elongated sealing section to a lowermost one of the elongated metal members embedded therein in a range of 1-16 mm; and
a distance from an upper edge of the at least one elongated sealing section to an uppermost one of the elongated metal members embedded therein is in a range of 1-16 mm.

17. The elongated door seal according to claim 15, wherein:
a lower part of at least one of the sealing sections is made of a material with a Shore A score which is at least 4 lower than a Shore A score of an uppermost part of the at least one sealing section; and
a ratio between a thickness of the uppermost part of the at least one sealing section and the Shore A score of the uppermost part of the at least one sealing section is such that a result of a multiplication of the thickness in mm by the Shore A score is a number in the range of 350-2,000.

18. The elongated door seal according to claim 15, wherein:
the at least one elongated sealing section comprises a sealing section with a substantially square, substantially rectangular or substantially trapezoid cross section; and
the at least one rodent proofing barrier comprising the elongated metal members is embedded in the substantially square, substantially rectangular or substantially trapezoid sealing section; and
a distance from a lower edge of the sealing section to a lowermost one of the elongated metal members in the sealing section is in the range of 1-16 mm;
a distance from an upper edge of the sealing section to an uppermost one of the elongated metal members in the sealing section is in the range of 1-16 mm;
a thickness of an uppermost part of the sealing section is in the range of 10-150 mm; and
a height of the sealing section is in the range of 10-150 mm.

19. The elongated door seal according to claim 18, wherein a lower part of the sealing section is made of a material with a Shore A score which is at least 4 lower than a Shore A score of the uppermost part of the sealing section.

20. The elongated door seal according to claim 15, further comprising:
at least two elongated attaching members each having a substantially T-shaped, substantially samba drum beater-shaped or substantially trapezoid-shaped cross section for attaching the door seal i) to an elongated mounting strip with correspondingly shaped mounting slots or ii) to an underside of a door blade with correspondingly shaped mounting slots;
at least one flexible elongated part protruding from an underside of the at least one sealing section; and
an elongated brush strip mounted in an elongated slot formed by the outer material of the door seal.

21. The elongated door seal according to claim 15, wherein:
the door seal is elastic; and
the at least one elongated sealing section comprises a blade shaped sealing section with the rodent resistant barrier of elongated metal members embedded therein;
the elongated door seal further comprising;
two elongated and substantially L-shaped mounting sections each with a substantially L-shaped attaching member disposed on opposite sides of a cross section of the blade shaped sealing section, for;
i) mounting the door seal in a mounting strip equipped with elongated mounting slots with a cross sectional shape corresponding to a substantially L-shaped cross-sectional shape of the substantially L-shaped mounting sections; or
ii) for mounting the door seal on an underside of a door blade of an up-and-over door with elongated mounting slots with a cross sectional shape corresponding to the substantially L-shaped cross-sectional shape of the substantially L-shaped mounting sections;
wherein;
a breadth of the door seal is 4-30 cm; and
a thickness of the blade shaped sealing section is 2-20 mm.

22. The elongated door seal according to claim 21, further comprising:
at least one flexible elongated part protruding from one side of the blade shaped sealing section and extending parallel to a longitudinal direction of the blade shaped sealing section;
wherein;
a breadth of the at least one protruding part is in a range 1-5 mm; and
a height of the at least one protruding part is in a range 1-5 mm.

23. The elongated door seal according to claim 22, wherein the at least one flexible elongated protruding parts is made from a softer material than a main part of the blade shaped sealing section with a difference in Shore A score of at least 4.

24. The elongated door seal according to claim 15, wherein:
the door seal is elastic; and
the at least one elongated sealing section comprises a blade shaped sealing section the rodent resistant barrier of elongated metal members embedded therein;
the elongated door seal further comprising;
at least one elongated and substantially T-shaped, substantially samba drum beater-shaped or substantially trapezoid-shaped mounting section for;
i) mounting the door seal in a mounting strip equipped with a corresponding number of correspondingly shaped elongated mounting slots; or
ii) mounting the door seal on an underside of the door blade of an up-and-over door with a corresponding number of correspondingly shaped elongated mounting slots;
wherein;
a breadth of the door seal is 4-30 cm; and
a thickness of the sealing section is 2-20 mm.

25. The elongated door seal according to claim 24, further comprising:
at least one flexible elongated part protruding from one side of the blade shaped sealing section and extending parallel to a longitudinal direction of the blade shaped sealing section;
wherein;
a breadth of the protruding part is in a range 1-5 mm; and
a height of the protruding part is in a range 1-5 mm.

26. The elongated door seal according to claim 25, wherein the at least one flexible elongated protruding part is made from a softer material than a main part of the sealing section with a difference in Shore A score of at least 4.

27. The elongated door seal according to claim 15, wherein the outer body of polymer material comprises a thermoplastic elastomer.

28. An assembly comprising a door seal according to claim 21 and a mounting strip having two mounting slots for receiving the substantially L-shaped attaching members of the mounting sections.

29. A method for rodent proofing an up-and-over door, comprising:
mounting a door seal according to claim 15 a door blade of the up-and-over door.
